(19) United States
(12) Patent Application Publication
(10) Pub. No.: US 2026/0369004 A1
(43) Pub. Date: Nov. 19, 2026

(54) THREE-DIMENSIONAL ITEM VISUALIZATION IN EXTENDED REALITY ENVIRONMENTS

(71) Applicant: eBay Inc., San Jose, CA (US)

(72) Inventors: Junjuan Shi, Shanghai (CN); Wei Liu, Shanghai (CN); Zhichao Han, Shanghai (CN); Jingjing Cai, Shanghai (CN); Yujia Xi, Shanghai (CN); Zehao Wu, Shanghai (CN)

(21) Appl. No.: 19/206,546

(22) Filed: May 13, 2025

(51) Int. Cl. G06T 17/00; G06Q 30/0601; G06T 19/00; G06V 10/82

(52) U.S. Cl. CPC G06T 17/00; G06Q 30/0643; G06T 19/006; G06V 10/82

(57) ABSTRACT

A system may cause presentation of a three-dimensional (3D) environment and presentation of a virtual interactive interface. The virtual interface may include one or more selectable items of a publication platform. A selection of an item from among the one or more selectable items of the publication platform may be received from a user via the virtual interactive interface. A 3D model of the item may be accessed. Based on the 3D model of the item, the system may cause presentation of a virtual representation of the item within the 3D environment.

### TECHNICAL FIELD

Embodiments of the present disclosure relate generally to three-dimensional (3D) visualization and, more particularly, but not by way of limitation, to methods and systems for generating and presenting a virtual 3D representation of an item from a publication platform within an extended reality (XR) environment.

### BACKGROUND

Publication platforms serve various purposes, including educational content sharing, scientific research dissemination, news distribution, business transaction, professional networking, etc. These platforms enable users to publish, discover, and interact with different types of content through digital interfaces.

Among different types of publication platforms, e-commerce platforms have become increasingly prevalent, facilitating transactions between buyers and sellers across various categories of items. Traditional e-commerce platforms primarily rely on two-dimensional images and text descriptions to present products, which often provides an incomplete or inaccurate representation of items'physical characteristics, dimensions, and appearance. This limitation creates uncertainty for users trying to find target products and often causes them to make uninformed purchase decisions.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of examples, and not limitations, in the accompanying figures.

FIG. 1 is a block diagram showing an example data system, according to various examples of the present disclosure.

FIG. 2A is a diagram illustrating an example scenario of interacting with a virtual interactive interface in an extended reality (XR) environment, according to various examples of the present disclosure.

FIG. 2B is a diagram illustrating an example virtual interactive interface for item selections in the XR environment, according to various examples of the present disclosure.

FIG. 3 is a diagram illustrating an example view of the XR environment, according to various examples of the present disclosure.

FIG. 4 is a schematic diagram for generating a 3D model of an item, according to various examples of the present disclosure.

FIG. 5 is a flowchart illustrating an example method for presenting a virtual representation of a selected item within an XR environment, according to various examples of the present disclosure.

FIG. 6 is a flowchart illustrating an example method for generating a 3D model of an item based on image(s) of the item, according to various examples of the present disclosure.

FIG. 7 is a flowchart illustrating an example method for training a multi-view diffusion model, according to various examples of the present disclosure.

FIG. 8 is a block diagram illustrating a representative software architecture, which may be used in conjunction with various hardware architectures herein described, according to various examples of the present disclosure.

FIG. 9 is a block diagram illustrating components of a machine able to read instructions from a machine-readable medium and perform any one or more of the methodologies discussed herein, according to various examples of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details.

Computer vision and 3D modeling technologies have enabled the creation of digital representations of products on e-commerce platforms. However, they typically only display these 3D models within webpage interfaces, limiting users'ability to fully evaluate products in real-world contexts. As a result, users may still be dissatisfied with the actual size and overall appearance when they receive the products. In addition, the creation of the 3D model usually requires a careful examination of the entire outer surface (and inner surface) of the item which is both time consuming and costly.

Various embodiments include systems, methods, and non-transitory computer-readable media for generating and presenting three-dimensional (3D) representations of items within extended reality (XR) environments. The system enables users wearing XR devices to view and interact with virtual representations of items from a publication platform through an immersive visualization experience that accurately reflects the physical characteristics, dimensions, and appearance of the items.

In some examples, XR includes both virtual reality (VR) and augmented reality (AR) technologies, where VR creates fully immersive digital environments by replacing the user's view of the physical world with computer-generated content, while AR overlays digital content onto the user's view of the physical world. The VR devices may include outward-facing cameras that can capture the surrounding physical environment in real-time, enabling users to see their surroundings even while wearing a non-transparent head-mounted display.

When viewing an item on the publication platform, the publication platform may enable a presentation of an interactive interface. The interactive interface may include XR visual content presented on the user's XR device. The interactive interface may include a list of items on the publication platforms that users can scroll through using hand gestures. For e-commerce platforms, the interactive interface may also include prices, item details, manufacturer information, and interactive controls such as preview and purchase buttons. Users may interact with the list of the items through hand gestures, including but not limited to point-based selection, tactile scrolling motions, and alphanumeric inputs for searching. The system may also support motion-based gestures like acceleration and rotation movements to navigate through content or switch between categories.

Upon selecting to preview an item through the interactive interface, the system accesses or generates a three-dimensional (3D) model of the item. In some examples, the 3D model of the item may be generated by a depth camera. The depth camera may include Light Detection and Ranging (LiDAR) sensors, which emit infrared light pulses and measure their reflections to precisely calculate distances between the sensor and item surfaces. These depth measurements create point clouds that can be processed to determine the item's physical geometry and dimensions. Alternatively, the 3D model of the item may be generated based on multiple images of the item at multiple angles using a sparse-view reconstruction model. The sparse-view reconstruction model analyzes spatial relationships between the different views to generate the 3D model that preserves the item's physical characteristics. In some examples, the multiple images may be directly captured at different viewing angles of the item, e.g., front view, 45-degree views, side views, top view, bottom view, etc. In some other examples, multiple images may be generated from a single image of the item using a multi-view diffusion model, which predicts how the item would appear from different viewing angles.

In some examples, the multi-view diffusion model may be trained using a preliminary model and training data sets. Each training data set includes an reference image paired with a reference 3D model. The system generates first images at different viewing angles from the 3D model, executes the preliminary model to generate second images at those angles from the single reference image, determines reconstruction loss between the images, and updates the model based on the reconstruction loss. In some examples, the sparse-view reconstruction model may be trained using a preliminary model and training data sets. Each training data set may include multiple images of a training item at different viewing angles paired with a reference 3D model of that training item. The system may execute the preliminary model to generate a 3D model from the multiple training images, determine a reconstruction loss by comparing the generated 3D model with the reference 3D model, and update the preliminary model based on the reconstruction loss. These training processes may continue iteratively until preset conditions are satisfied.

The 3D model of the item may be presented in an XR environment in different ways. In some examples, when using a VR device with outward-facing cameras, the system may display real-time camera feeds from the physical environment as a background and inserting the 3D model into the camera feeds. In some other examples, when using an AR device with a transparent display, the system may overlay a presentation of the 3D model at an appropriate location on the user's view of the physical environment.

The system may maintain proper visualization of the 3D model of the item through simultaneous localization and mapping (SLAM). SLAM technology continuously tracks the position and orientation of the XR device to update the presentation of 3D model of the item accordingly. In some examples, the user may interact with the 3D model through hand gestures, e.g., pinching to resize objects, dragging to reposition them within the environment, and holding to rotate and examine items from different angles.

In some examples, the system implements solid collision detection between the 3D model of the item and physical objects in the environment (or another 3D model of another item). This prevents the 3D model of the item from appearing to intersect with real-world objects. The solid collision detection may include detecting solid objects in the environment and constraining placement of the 3D model of the item accordingly. The system may provide spatial anchoring capabilities that allow users to fix the 3D model of the item at specific locations within the XR environment, ensuring items remain in their intended positions even as users move around.

The system may have environment sharing capabilities. For example, when a user is interested in purchasing a sofa, they can preview the virtual sofa in their real home environment using their XR device and share this visualization with others. The shared content may include computer vision video or images showing the virtual sofa placed in the actual space, or an interactive XR environment that other users can join to view and interact with the virtual item together. This allows multiple users, such as friends or family members, to collaboratively evaluate how items would fit and appear in their intended environment before making purchase decisions.

The present disclosure provides significant technical improvements over conventional publication platforms. As mentioned above, traditional publication platforms (e.g., e-commerce platforms) rely solely on two-dimensional images and text descriptions, that fail to accurately convey to users how items would appear and fit in their intended environments. In contrast, the disclosed system enables immersive three-dimensional visualization through extended reality technologies, allowing users to accurately assess items' physical characteristics, dimensions, and appearance through virtual representations. The present disclosure provides various ways to accurately present a virtual representation of the item in a virtual 3D environment. Even if the 3D model of the item is not readily available, the present system can generate the 3D model based on a single image of the item, thereby making almost all items published on the publication platform available to be previewed in the 3D environment. The system's advanced spatial computing capabilities, including collision detection, surface recognition, and environment sharing features, eliminate uncertainty by enabling users to preview items at actual scale within their physical spaces and collaborate with others in making purchase decisions. These technical improvements streamline the online shopping experience while ensuring users can make confident, well-informed decisions based on realistic visualization rather than abstract product information.

Reference will now be made in detail to embodiments of the present disclosure, examples of which are illustrated in the appended drawings. The present disclosure may, however, be embodied in many different forms and should not be construed as being limited to the embodiments set forth herein.

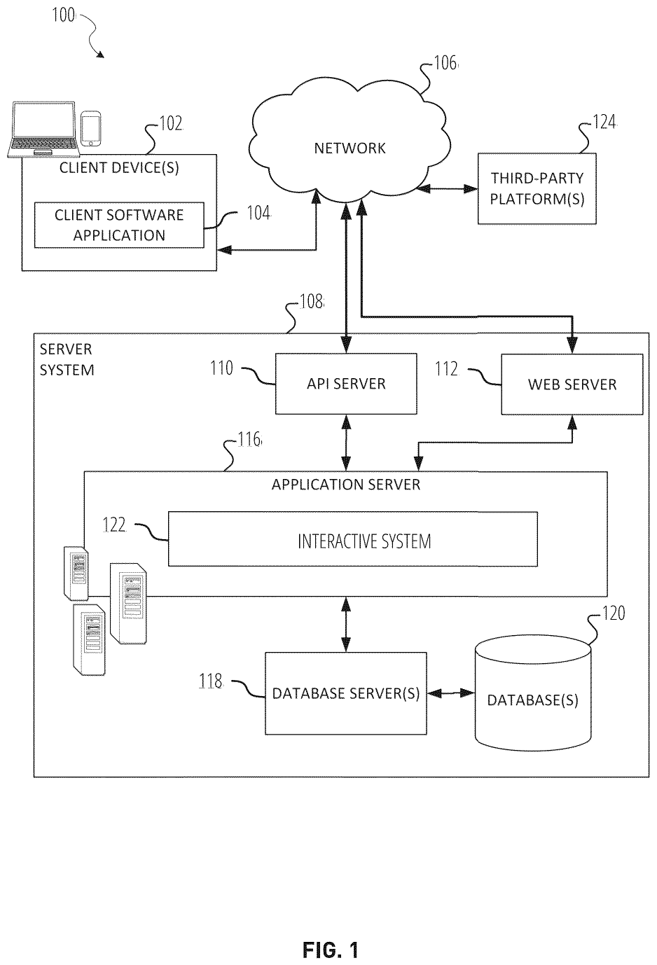

FIG. 1 is a block diagram showing an example data system 100 that includes an interactive system 122 (also referred to as system 122), according to various embodiments of the present disclosure. As shown, the data system 100 includes one or more client devices 102, a server system 108, and a network 106 (e.g., Internet, wide-area-network (WAN), local-area-network (LAN), wireless network) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106. In some examples, the client device 102 may be or include an XR device (e.g., a VR device or an AR device) or support presentation of an XR environment. Although the client device 102 is illustrated as a mobile device or laptop computer in FIG. 1, the client device 102 may be implemented as a head-mounted display device that enables users to view and interact with virtual content in the XR environment. In some examples, the client device 102 may include both a mobile device or a laptop computer as illustrated in FIG. 1 and an XR device.

The server system 108 provides server-side functionality via the network 106 to the client software application 104. While certain functions of the data system 100 are described herein as being performed by the interactive system 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the interactive system 122. Such operations include transmitting data from the interactive system 122 to the client software application 104, receiving data from the client software application 104 at the interactive system 122, and the interactive system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, an Application Program Interface (API) server 110 and a web server 112 is coupled to an application server 116, which hosts the interactive system 122. The application server 116 is communicatively coupled to a database server 118, which facilitates access to a database 120 that stores data associated with the application server 116, including data that may be generated or used by the interactive system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation, user registration; login functionality; data object operations (e.g., generating, storing, retrieving, encrypting, decrypting, transferring, access rights, licensing); and/or user communications.

The server system 108, or the interactive system 122 may extract user data from one or more third-party platforms 124 (e.g., third-party social media platforms).

Through one or more web-based interfaces (e.g., web-based user interfaces), the web server 112 can support various functionality of the interactive system 122 of the application server 116.

In some examples, the interactive system 122 triggers components of the client software application 104 to display a virtual interactive interface including selectable items from a publication platform on the client device 102. The virtual interactive interface may include prices, manufacturer information, item descriptions, and interactive controls such as preview and purchase buttons. The interactive system 122 may obtain a pre-trained sparse-view reconstruction model and a pre-trained multi-view diffusion model from the database 120 or the third-party platform 124 and execute the obtained models to generate a 3D model of the item selected by the user through the virtual interactive interface. Alternatively, the interactive system 122 may obtain an existing 3D model of the item directly from the database 120 or the third-party platform 124. The interactive system 122 may cause presentation of the 3D model in an XR environment of the client device 102. The interactive system 122 may also trigger environment sharing features via the application server 116 to enable collaborative visualization with other users.

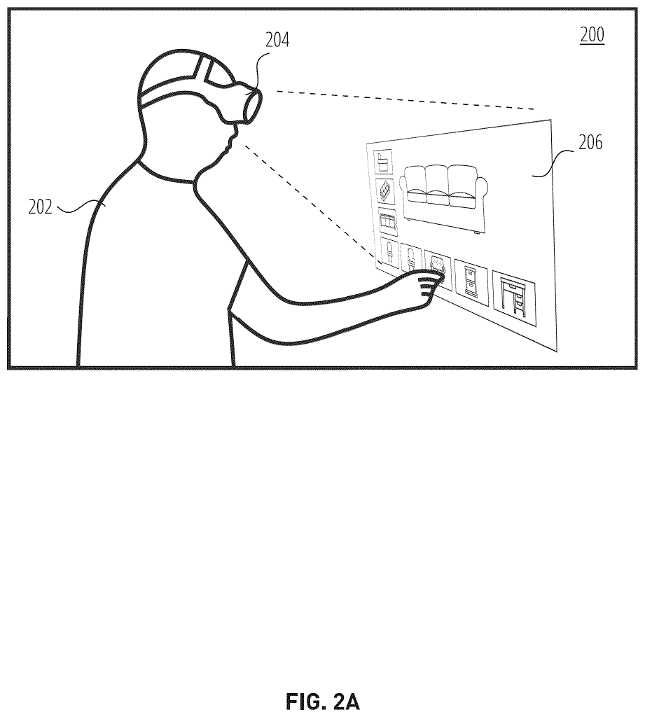

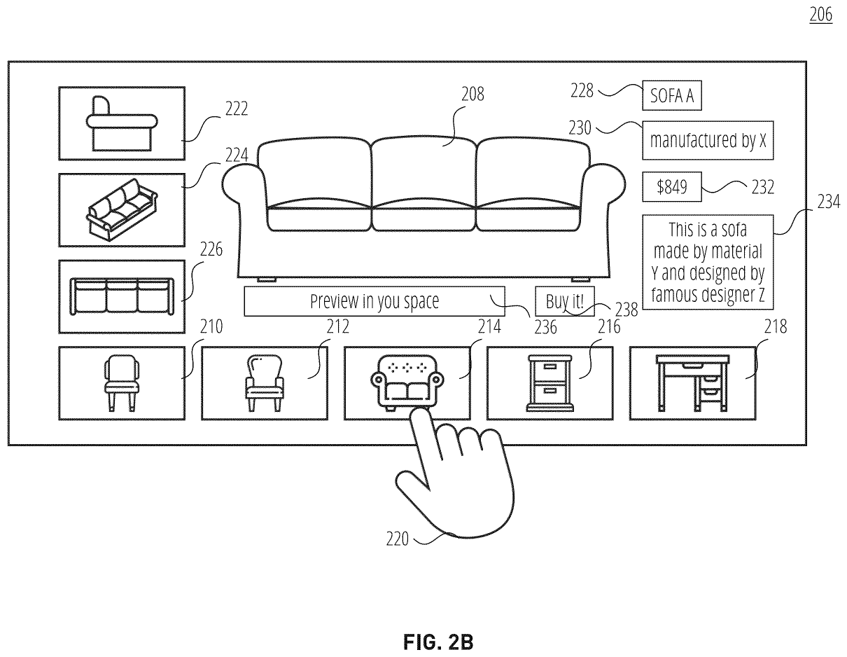

FIG. 2A is a diagram illustrating an example scenario 200 of interacting with a virtual interactive interface 206 in an XR environment according to various examples of the present disclosure.

As shown in FIG. 2A, a user 202 may wear an XR device 204 (e.g., a VR device with outward-facing cameras or an AR device with a transparent display) to view and interact with a virtual interactive interface 206. The XR device 204 enables the user 202 to see their surroundings while viewing virtual content, either through real-time camera feeds displayed in a VR device or through direct view of the environment through an AR device's transparent display.

In some examples, the XR device 204 may include various hardware components to enable immersive visualization and interaction. The XR device 204 may include display components such as high-resolution displays or transparent lenses for presenting virtual content, and outward-facing cameras for capturing the surrounding physical environment. The XR device 204 may include a projector or a light emitting component to project virtual content to a field of view of the user 202. The XR device 204 may also include motion and position tracking components such as accelerometers, gyroscopes, and spatial sensors to track the user's head movements and maintain proper visualization. Additionally, the XR device 204 may include input/output components such as gesture sensors for hand tracking, haptic feedback systems for tactile responses, and spatial audio systems for sound generation.

The virtual interactive interface 206 may be presented within the user's field of view through the XR device 204, allowing the user 202 to browse and select items from a publication platform. Users can interact with the virtual interactive interface 206 through various input methods including point-based selection, tactile scrolling motions, alphanumeric inputs for searching, and motion-based gestures like acceleration and rotation movements to navigate through the displayed content. Details regarding the virtual interactive interface 206 may be found elsewhere in the present disclosure, e.g., FIG. 2B and descriptions thereof.

FIG. 2B is a diagram illustrating an example virtual interactive interface 206 for item selections in the XR environment, according to various examples of the present disclosure.

As shown in FIG. 2B, the virtual interactive interface 206 may display a currently viewed item 208 (e.g., a sofa) in a central viewing area. The virtual interactive interface 206 may also display similar or related items 210, 212, 214, 216, and 218 that users can browse through next to or below the currently viewed item 208. For VR devices, a virtual representation 220 of the user's hand may be displayed. For AR devices with transparent displays, the user's actual hand may be visible through the display as the representation 220.

The virtual interactive interface 206 may include multiple images (e.g., images 222, 224, and 226) showing the currently viewed item 208 from different viewing angles to help users better understand the item's physical characteristics. The virtual interactive interface 206 may display item information including the item name 228 (e.g., “SOFA A”), manufacturer information 230 (e.g., “manufactured by X”), price 232 (e.g., “$849”), and a detailed item description 234 describing the item's material and designer.

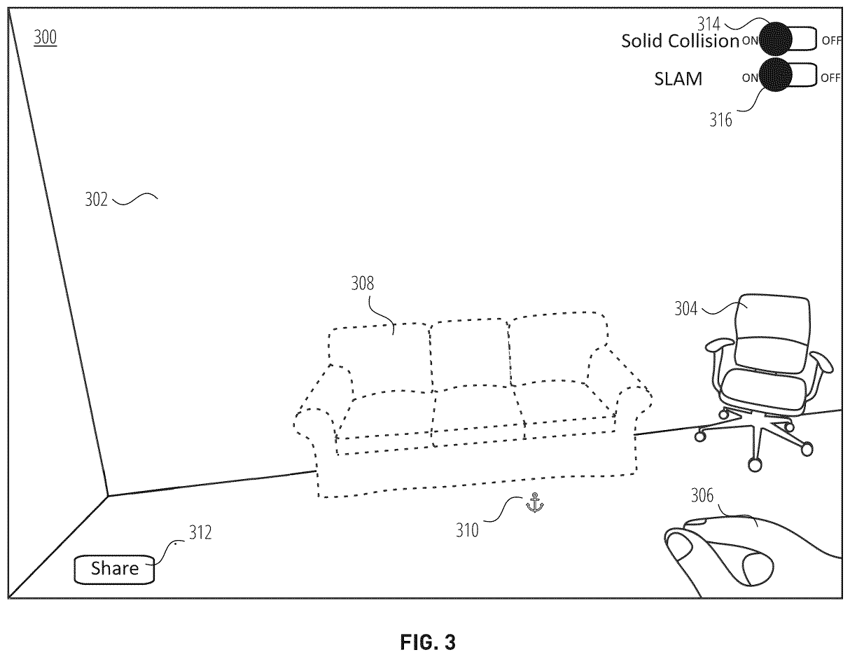

The virtual interactive interface 206 may include interactive controls such as a preview button 236 that, when selected, causes the virtual interactive interface 206 to switch to a presentation of a 3D XR environment (e.g., XR environment 300 shown in FIG. 3) where users can view and interact with a virtual representation of the item 208 at actual scale. A purchase button 238 enables users to proceed with buying the item by accessing shopping cart or processing payment.

It should be noted that the layouts, arrangements, and presentations of various components and elements shown in FIGS. 2A and 2B are for illustrative purposes only and shall not be construed as limiting the scope of the present disclosure. The virtual interactive interface 206 may be implemented with different layouts, arrangements, and presentations of the components and elements while still achieving the functionalities and features described herein.

FIG. 3 is a diagram illustrating an example view of the XR environment 300, according to various examples of the present disclosure.

As shown in FIG. 3, the XR environment 300 may include a presentation 302 of a real-world environment. For VR devices, the presentation 302 may include real-time camera feeds captured by outward-facing cameras of the VR device. For AR devices with transparent displays, the presentation 302 may include direct view of the real-world environment through the transparent displays.

The XR environment 300 may include physical objects such as a real-world chair 304 that may be either captured by the cameras and presented as part of the VR device's camera feeds, or directly visible through the transparent display of the AR device. The XR environment 300 may also show fingers 306 of the user that may be either virtually represented in the VR device's display or directly visible through the AR device's transparent display for interaction with virtual content.

The XR environment 300 may include a virtual representation 308 of a 3D model of an item (e.g., the currently viewed item 208, a sofa). The virtual representation 308 may be displayed at actual scale within the XR environment 300, allowing users to accurately assess the item's physical dimensions and appearance. The actual scale of the item may be determined based on item specifications published on the publication platform. A user can manipulate the virtual representation 308 through hand gestures, including pinching to resize, dragging to reposition, and holding to rotate the item, etc.

The XR environment 300 may include interactive controls for enhanced visualization features. An anchor button 310 enables fixing the virtual representation 308 at a specific location within the XR environment 300, ensuring the item remains in place even as users move around. A share button 312 enables users to share visualizations with others through computer vision video, images, or interactive XR environments that other users can join.

The XR environment 300 may include toggle controls for advanced spatial computing capabilities. For example, a solid collision detection toggle 314 may be switched on to prevent the virtual representation 308 from intersecting with detected real-world objects by implementing collision detection between virtual items and physical objects or between virtual items. A simultaneous localization and mapping (SLAM) toggle 316 may be switched on to enable continuous tracking of the XR device's position and orientation to maintain proper visualization of virtual content within the physical space when the user moves around or changes their viewing angle.

The XR environment 300 may include navigation controls such as a back button to return to the virtual interactive interface 206 and a finish button to complete the preview session. These controls allow users to seamlessly transition between different views and conclude their visualization experience.

It should be noted that the layouts, arrangements, and presentations of various components and elements shown in FIG. 3 are for illustrative purposes only and shall not be construed as limiting the scope of the present disclosure.

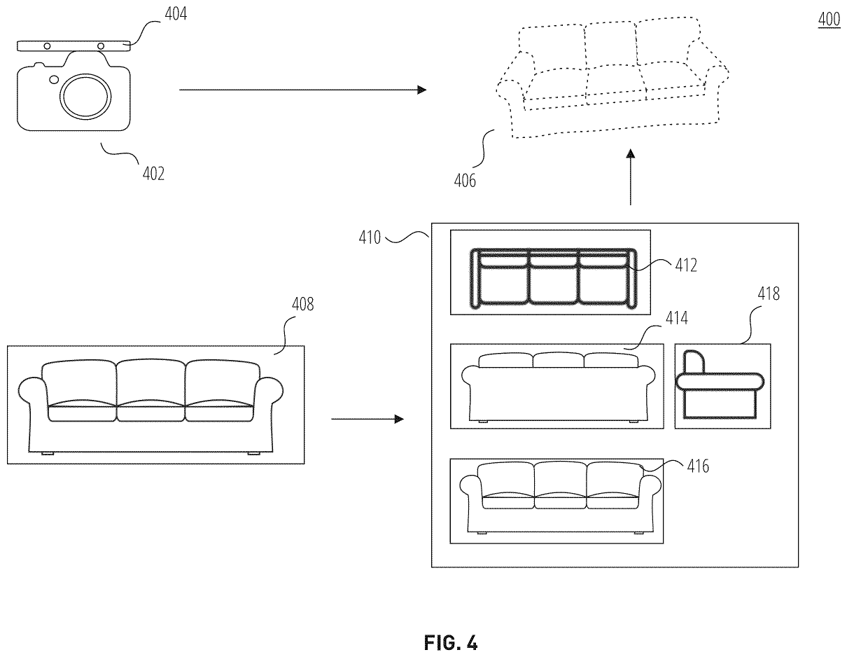

FIG. 4 is a schematic diagram 400 for generating a 3D model 406 of an item, according to various examples of the present disclosure. The schematic diagram 400 may include taking different approaches for generating the 3D model 406, including depth camera scanning, image-based reconstruction, etc.

As shown in FIG. 4, a depth camera 402 may include Light Detection and Ranging (LiDAR) components 404 that emit infrared light pulses and measure their reflections to precisely calculate distances between the sensor and item surfaces. The depth measurements create point clouds that capture the item's physical geometry, dimensions, and surface characteristics. The point clouds may then be processed using computer vision algorithms to generate the 3D model 406.

In some examples, the 3D model 406 may be generated based on a single image 408 of the item captured at a viewing angle. For example, the system executes a multi-view diffusion model, which has been trained on paired image-model data, to generate a set of synthetic images 410 showing the item from multiple predicted viewing angles. These synthetic views may include different perspectives such as a top view 412 showing the item from above, a back view 414 showing the rear of the item, a front view 416 showing the front surface, and a side view 418 showing the lateral profile.

The system processes these multiple views through a sparse-view reconstruction model that analyzes the spatial relationships and visual correspondences between the different perspectives. By combining information from all available views, whether directly captured or synthetically generated, the sparse-view reconstruction model generates the 3D model 406 that preserves the item's physical characteristics, proportions, and geometric details. The resulting 3D model enables accurate visualization of the item from any viewing angle within the XR environment.

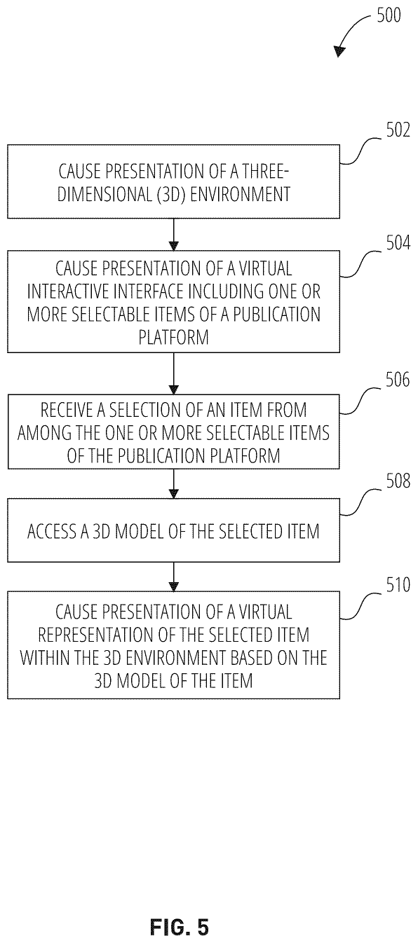

FIG. 5 is a flowchart illustrating an example method 500 for presenting a virtual representation (e.g., virtual representation 308) of a selected item (e.g., item 208) within an XR environment (e.g., XR environment 300), according to various examples of the present disclosure. It will be understood that example methods described herein may be performed by a machine in accordance with some embodiments. For example, part or all of method 500 can be performed by the client device 102 (e.g., an XR device), the server system 108, the interactive system 122, or individual components thereof. An operation of method 500 may be performed by one or more hardware processors (e.g., central processing units or graphics processing units) of a computing device (e.g., a desktop, server, laptop, mobile phone, tablet, etc.), which may be part of a computing system based on a cloud architecture. The method 500 may also be implemented in the form of executable instructions stored on a machine-readable medium or in the form of electronic circuitry. For instance, the operations of method 500 may be represented by executable instructions that, when executed by a processor of a computing device, cause the computing device to perform method 500. Depending on the embodiment, an operation of the method 500 may be repeated in different ways or involve intervening operations not shown. Though the operations of the method 500 may be depicted and described in a certain order, the order in which the operations are performed may vary among embodiments, including performing certain operations in parallel.

At operation 502, a system (e.g., the interactive system 122) causes presentation of a three-dimensional (3D) environment. For VR devices with outward-facing cameras, the system may display real-time camera feeds as a background environment. For AR devices with transparent displays, the system may enable direct view of the physical surroundings. In some examples, the system may implement simultaneous localization and mapping (SLAM) to continuously track the position and orientation of the XR device. It should be noted that in order to “cause presentation of a virtual representation,” the system may cause the XR device with data defining the virtual representation along with a set of machine-readable instructions that, when interpreted by the XR device, cause the device to present the virtual representation.

At operation 504, the system (e.g., the interactive system 122) causes presentation of a virtual interactive interface. For VR devices, the system may trigger the display components to present the virtual interactive interface on high-resolution displays. For AR devices, the system may project the virtual interactive interface in front of transparent display components to overlay the virtual interactive interface onto the user's field of view.

The virtual interactive interface may include one or more selectable items of a publication platform. The virtual interactive interface may display item details including titles, prices, manufacturer information, etc., and interactive controls. In some examples, the system may arrange these elements in an organized spatial layout that appears to float in front of the user while maintaining visibility of the surrounding environment.

In some examples, the system may detect and track user hand gestures through input/output components including gesture sensors, motion tracking sensors, and spatial sensors integrated into the XR device. The system may process sensor data to recognize specific gesture patterns such as point-based selection motions, tactile scrolling movements, and grab-and-drag interactions. When a recognized gesture is detected within the interaction zone of a selectable interface element, the system may trigger appropriate visual feedback and execute the corresponding interface action.

At operation 506, the system (e.g., the interactive system 122) receives, from a user via the virtual interactive interface, a selection of an item from among the one or more selectable items of the publication platform. In some examples, the system may detect user hand gestures through input/output components including gesture sensors, motion tracking sensors, and spatial sensors integrated into the XR device. The system may process sensor data to recognize specific gesture patterns for item selection, such as point-based selection motions where the user points at or taps on a selectable item in the virtual interactive interface.

In some examples, the system may provide visual feedback when an item is selected, such as highlighting or emphasizing the selected item within the virtual interactive interface. The system may also provide haptic feedback through the XR device's haptic output components to confirm successful item selection.

For VR implementations, the system may detect interactions between a virtual representation of the user's hand and selectable items in the virtual interactive interface. For AR implementations with transparent displays, the system may detect interactions between the user's actual hand visible through the display and the overlaid virtual interface elements.

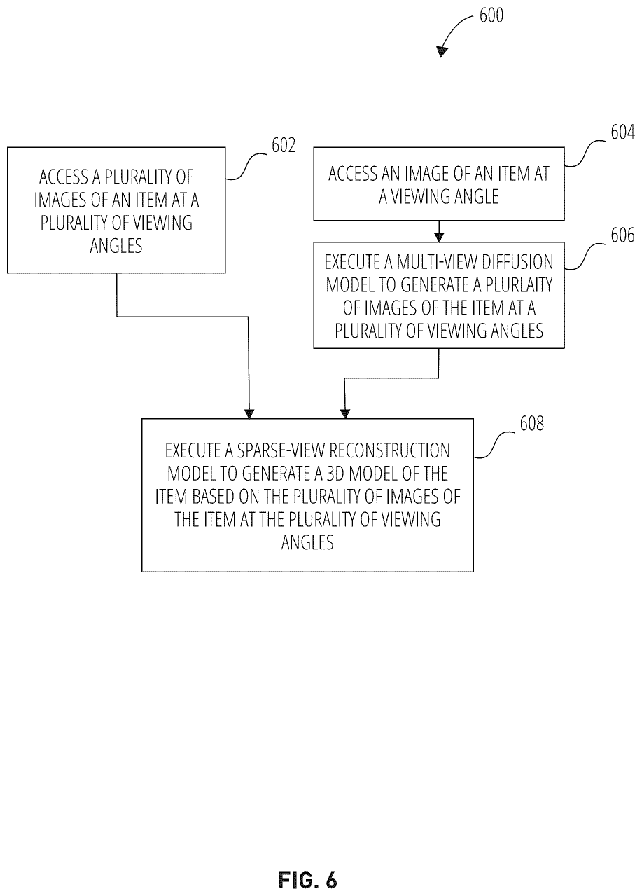

At operation 508, the system (e.g., the interactive system 122) accesses a 3D model of the selected item. In some examples, the system may obtain the 3D model from a database containing pre-generated models. Alternatively, the system may generate the 3D model using depth camera data from LiDAR sensors that measure distances to determine physical geometry. Alternatively, the system may execute a sparse-view reconstruction model to generate the 3D model by analyzing spatial relationships between multiple images of the item captured at different viewing angles. Details regarding the generation of the 3D model may be found elsewhere in the present disclosure, e.g., FIG. 6 and descriptions thereof.

At operation 510, the system (e.g., the interactive system 122) causes presentation of a virtual representation of the selected item within the 3D environment based on the 3D model of the item. In some examples, the virtual representation may be displayed at actual scale to match real-world dimensions. Users may resize the representation through pinching gestures, reposition the representation through dragging motions, and/or rotate the representation through holding gestures to examine different angles.

FIG. 6 is a flowchart illustrating an example method 600 for generating a 3D model of an item based on image(s) of the item, according to various examples of the present disclosure. It will be understood that example methods described herein may be performed by a machine in accordance with some embodiments. For example, part or all of method 600 can be performed by the client device 102 (e.g., an XR device), the server system 108, the interactive system 122, or individual components thereof. An operation of method 600 may be performed by one or more hardware processors (e.g., central processing units or graphics processing units) of a computing device (e.g., a desktop, server, laptop, mobile phone, tablet, etc.), which may be part of a computing system based on a cloud architecture. The method 600 may also be implemented in the form of executable instructions stored on a machine-readable medium or in the form of electronic circuitry. For instance, the operations of method 600 may be represented by executable instructions that, when executed by a processor of a computing device, cause the computing device to perform method 600. Depending on the embodiment, an operation of the method 600 may be repeated in different ways or involve intervening operations not shown. Though the operations of the method 600 may be depicted and described in a certain order, the order in which the operations are performed may vary among embodiments, including performing certain operations in parallel.

At operation 602, a system (e.g., the interactive system 122) accesses a plurality of images of an item at a plurality of viewing angles. In some examples, the plurality of images may be directly captured and uploaded by sellers through the publication platform. The images may include standardized views such as front view, 45-degree views, side views, top view, and bottom view to provide comprehensive visual coverage of the item. In some examples, the system may process the uploaded images to ensure consistent lighting, scale, and orientation before using them for 3D model generation.

Alternatively, at operation 604, the system (e.g., the interactive system 122) accesses an image of an item at a viewing angle. In some examples, the system may receive a single product image uploaded by a seller through the publication platform. The system may process the input image to normalize lighting conditions and remove background elements. The system may analyze the viewing angle of the input image to determine the camera position and orientation relative to the item.

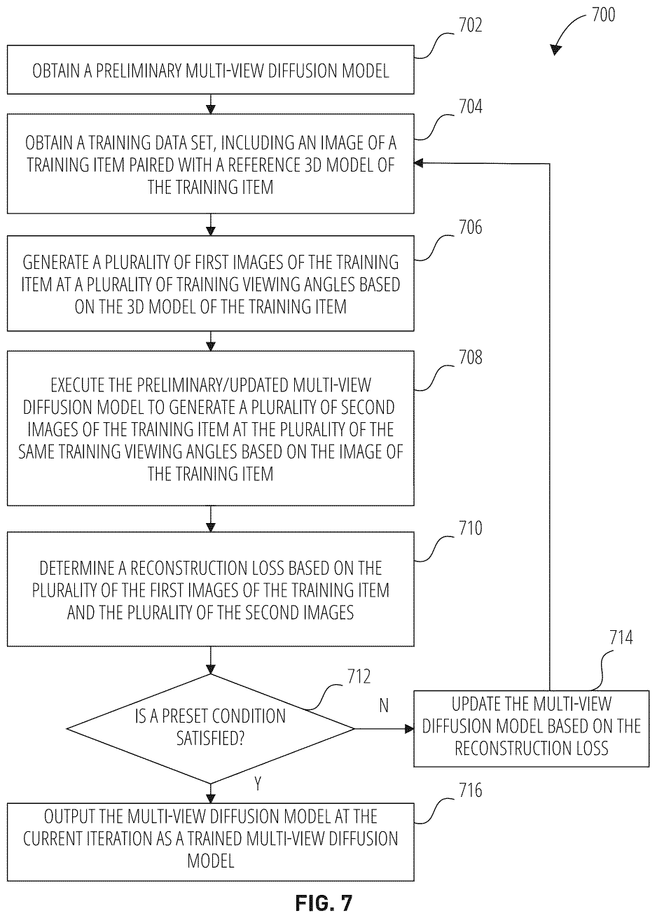

At operation 606, the system (e.g., the interactive system 122) executes a trained multi-view diffusion model to generate a plurality of images of the item at a plurality of viewing angles based on the image accessed at operation 604. The multi-view diffusion model may analyze visual patterns, textures, and geometric relationships in the input image to understand the item's 3D structure. The multi-view diffusion model may leverage its trained neural network or parameters to predict how the item would appear from different standardized viewing angles. The generated views may include front, back, sides, top, and bottom perspectives to enable complete 3D reconstruction. Details regarding the training of the multi-view diffusion model may be found elsewhere in the present disclosure, e.g., in FIG. 7 and descriptions thereof.

At operation 608, the system (e.g., the interactive system 122) executes a sparse-view reconstruction model to generate a three-dimensional (3D) model of the item based on the plurality of images of the item at the plurality of viewing angles (generated either at operation 602 or at operation 606). In some examples, the sparse-view reconstruction model may analyze corresponding points and features between different views to establish spatial relationships. The sparse-view reconstruction model may use these spatial relationships to determine the item's underlying 3D geometry and surface properties. The generated 3D model preserves the item's physical characteristics including dimensions, proportions, and material properties to enable accurate visualization in the XR environment.

FIG. 7 is a flowchart illustrating an example method 700 for training a multi-view diffusion model, according to various examples of the present disclosure. It will be understood that example methods described herein may be performed by a machine in accordance with some embodiments. For example, part or all of method 700 can be performed by the client device 102 (e.g., an XR device), the server system 108, the interactive system 122, or individual components thereof. An operation of method 700 may be performed by one or more hardware processors (e.g., central processing units or graphics processing units) of a computing device (e.g., a desktop, server, laptop, mobile phone, tablet, etc.), which may be part of a computing system based on a cloud architecture. The method 700 may also be implemented in the form of executable instructions stored on a machine-readable medium or in the form of electronic circuitry. For instance, the operations of method 700 may be represented by executable instructions that, when executed by a processor of a computing device, cause the computing device to perform method 700. Depending on the embodiment, an operation of the method 700 may be repeated in different ways or involve intervening operations not shown. Though the operations of the method 700 may be depicted and described in a certain order, the order in which the operations are performed may vary among embodiments, including performing certain operations in parallel.

At operation 702, a system (e.g., the interactive system 122) obtains a preliminary multi-view diffusion model. In some examples, the preliminary model may be initialized with random weights and parameters. Alternatively, the preliminary model may be pre-trained on a general dataset of 3D objects and their corresponding images. The preliminary model may be obtained from a model repository or third-party platform.

At operation 704, the system (e.g., the interactive system 122) obtains a training data set including an image of a training item paired with a reference 3D model of the training item. In some examples, the training data sets may be obtained from product catalogs containing both product images and corresponding 3D models. The training data may include standardized views of items captured under controlled lighting conditions. The reference 3D models may be generated using high-precision scanning equipment to ensure accuracy.

At operation 706, the system (e.g., the interactive system 122) generates a plurality of first images of the training item at a plurality of training viewing angles based on the 3D model of the training item. In some examples, the system may render the reference 3D model from standardized viewing angles such as front view, 45-degree views, side views, top view, and bottom view. The system may apply consistent lighting and material properties when generating the rendered views.

At operation 708, the system (e.g., the interactive system 122) executes the preliminary/updated multi-view diffusion model to generate a plurality of second images of the training item at the plurality of the same training viewing angles based on the image of the training item. In some examples, the multi-view diffusion model analyzes visual patterns and geometric relationships in the input image to predict views from different angles.

At operation 710, the system (e.g., the interactive system 122) determines a reconstruction loss based on the plurality of first images of the training item and the plurality of second images. For example, the system may compute pixel-wise differences between corresponding generated and reference views. Alternatively, the system may determine perceptual loss metrics that compare high-level feature representations. In some examples, the system may combine multiple loss terms to evaluate both visual quality and geometric accuracy.

At operation 712, the system (e.g., the interactive system 122) determines whether a preset condition is satisfied. In response to determining that the preset condition is satisfied, the method 700 may proceed to operation 716; otherwise, the method 700 may proceed to operation 714. The preset condition may include that number of training iterations reaches a threshold, the reconstruction loss falls below a threshold value, the model in current iteration passes an evaluation test on a validation dataset, all the training data sets are traversed, etc.

At operation 714, the system (e.g., the interactive system 122) updates the multi-view diffusion model based on the reconstruction loss. In some examples, the system may use gradient descent optimization to adjust model parameters. In some examples, the system may apply regularization techniques to prevent overfitting. In some examples, the system may use adaptive learning rates to improve training stability. The method 700 may proceed back to operation 704 to obtain an old training dataset or a new training data set.

At operation 716, the system (e.g., the interactive system 122) outputs the multi-view diffusion model at the current iteration as a trained multi-view diffusion model. In some examples, the system may save the trained model parameters to storage. In some examples, the system may evaluate the final model on a test dataset to verify performance. In some examples, the system may generate documentation about the model's training process and achieved metrics.

In some examples, the system may implement a virtual showroom feature that enables immersive product visualization and interaction. The virtual showroom may allow users to view and interact with multiple items simultaneously within a customizable 3D environment. In some examples, users may arrange virtual furniture and home goods in room-like settings to evaluate different design combinations. The system may implement spatial anchors to fix item positions, collision detection to prevent items from intersecting, and SLAM tracking to maintain proper visualization as users move through the space. In some examples, multiple users may join shared virtual showroom sessions to collaboratively browse and evaluate items.

In some examples, the system may include an AI recommendation bot that provides personalized product suggestions. The bot may analyze user preferences, browsing history, and interaction patterns within the XR environment to understand style preferences and shopping habits. In some examples, the bot may use computer vision to analyze the user's existing room layout and furniture through the XR device's cameras to suggest complementary items. The bot may provide real-time recommendations as users browse items, highlighting products that match their preferences in terms of style, size, color schemes and price ranges. The bot may also suggest alternative items when viewing specific products and help users discover related items that work well together.

In some examples, the sparse-view reconstruction model may be trained using paired datasets containing product images and corresponding ground truth 3D models, where the training data includes standardized product views captured under controlled lighting conditions with precise camera position and orientation information. The training process involves preprocessing training images to normalize lighting, scale, and orientation, extracting corresponding feature points between different views using computer vision techniques, learning spatial relationships between views through geometric analysis, and training the model to handle variations in materials, textures, and surface properties. The model is trained to identify matching points and features across multiple views, estimate camera positions and orientations, generate depth maps and point clouds, reconstruct complete 3D geometry preserving physical characteristics, and handle occlusions and incomplete view coverage. The training incorporates both synthetic and real product data to improve robustness, data augmentation with varying lighting and viewing conditions, loss functions evaluating geometric accuracy and visual quality, validation on held-out test sets, and iterative refinement based on reconstruction quality metrics.

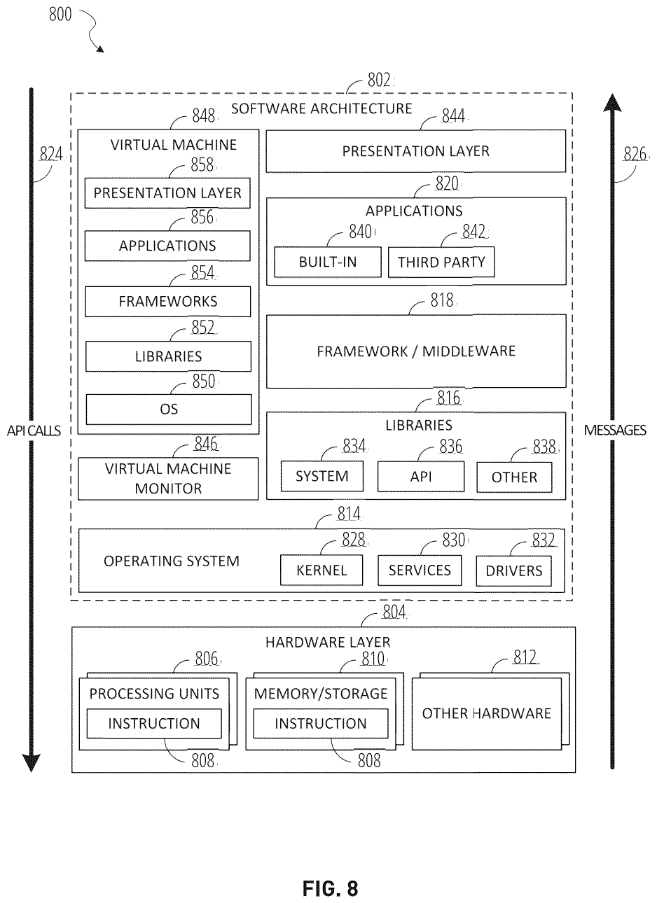

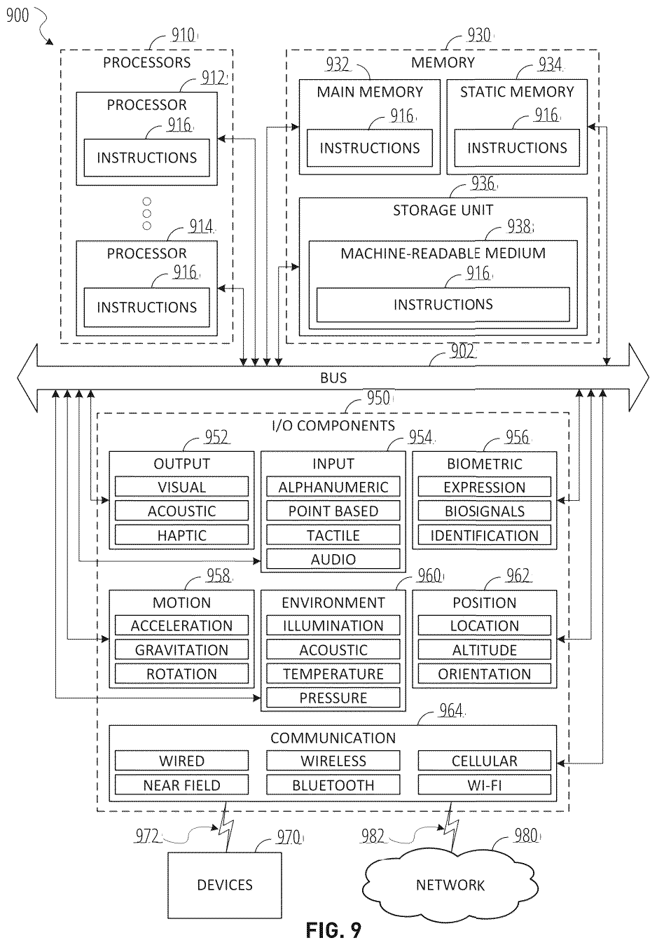

FIG. 8 is a block diagram illustrating an example of a software architecture 802 that may be installed on a machine, according to some example embodiments. FIG. 8 is merely a non-limiting example of a software architecture, and it will be appreciated that many other architectures may be implemented to facilitate the functionality described herein. The software architecture 802 may be executing on hardware such as a machine 900 of FIG. 9 that includes, among other things, processors 910, memory 930, and input/output (I/O) components 950. A representative hardware layer 804 is illustrated and can represent, for example, the machine 900 of FIG. 9. The representative hardware layer 804 comprises one or more processing units 806 having associated executable instructions 808. The executable instructions 808 represent the executable instructions of the software architecture 802. The hardware layer 804 also includes memory or storage modules 810, which also have the executable instructions 808. The hardware layer 804 may also comprise other hardware 812, which represents any other hardware of the hardware layer 804, such as the other hardware illustrated as part of the machine 900.

In the example architecture of FIG. 8, the software architecture 802 may be conceptualized as a stack of layers, where each layer provides particular functionality. For example, the software architecture 802 may include layers such as an operating system 814, libraries 816, frameworks/middleware 818, applications 820, and a presentation layer 844. Operationally, the applications 820 or other components within the layers may invoke API calls 824 through the software stack and receive a response, returned values, and so forth (illustrated as messages 826) in response to the API calls 824. The layers illustrated are representative in nature, and not all software architectures have all layers. For example, some mobile or special-purpose operating systems may not provide a frameworks/middleware 818 layer, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than by interfacing directly with the underlying operating system 814 functionality (e.g., kernel 828, services 830, or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks 818 (also sometimes referred to as middleware) may provide a higher-level common infrastructure that may be utilized by the applications 820 or other software components/modules. For example, the frameworks 818 may provide various graphical user interface functions, high-level resource management, high-level location services, and so forth. The frameworks 818 may provide a broad spectrum of other APIs that may be utilized by the applications 820 and/or other software components/modules, some of which may be specific to a particular operating system or platform.

The applications 820 include built-in applications 840 and/or third-party applications 842. Examples of representative built-in applications 840 may include, but are not limited to, a home application, a contacts application, a browser application, a book reader application, a location application, a media application, a messaging application, or a game application.

The third-party applications 842 may include any of the built-in applications 840, as well as a broad assortment of other applications. In a specific example, the third-party applications 842 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 842 may invoke the API calls 824 provided by the mobile operating system such as the operating system 814 to facilitate functionality described herein.

The applications 820 may utilize built-in operating system functions (e.g., kernel 828, services 830, or drivers 832), libraries (e.g., system libraries 834, API libraries 836, and other libraries 838), or frameworks/middleware 818 to create user interfaces to interact with users of the system. Alternatively, or additionally, in some systems, interactions with a user may occur through a presentation layer, such as the presentation layer 844. In these systems, the application/module “logic” can be separated from the aspects of the application/module that interact with the user.

Some software architectures utilize virtual machines. In the example of FIG. 8, this is illustrated by a virtual machine 848. The virtual machine 848 creates a software environment where applications/modules can execute as if they were executing on a hardware machine (e.g., the machine 800 of FIG. 9). The virtual machine 848 is hosted by a host operating system (e.g., the operating system 814) and typically, although not always, has a virtual machine monitor 846, which manages the operation of the virtual machine 848 as well as the interface with the host operating system (e.g., the operating system 814). A software architecture executes within the virtual machine 848, such as an operating system 850, libraries 852, frameworks 854, applications 856, or a presentation layer 858. These layers of software architecture executing within the virtual machine 848 can be the same as corresponding layers previously described or may be different.

FIG. 9 illustrates a diagrammatic representation of a machine 900 in the form of a computer system within which a set of instructions may be executed for causing the machine 900 to perform any one or more of the methodologies discussed herein, according to some embodiments. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions 916 may cause the machine 900 to execute the method 600 described above with respect to FIG. 6 and the method 700 described above with respect to FIG. 7. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example, the processors 910 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory 930 may include a main memory 932, a static memory 934, and a storage unit 936 including machine-readable medium 938, each accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion, and the grouping is in no way limiting. In some examples, the I/O components 950 may include output components 952 and input components 954. The output components 952 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 950 may include biometric components 956, motion components 958, environmental components 960, or position components 962, among a wide array of other components. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 962 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some examples, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 900 including processors 910), with these operations being accessible via a network (e.g., the Internet) and via one or more appropriate interfaces (e.g., an API). In certain embodiments, for example, a client device may relay or operate in communication with cloud computing systems and may access circuit design information in a cloud environment.

The performance of certain of the operations may be distributed among the processors, not only residing within a single machine 900, but deployed across a number of machines 900. In some example embodiments, the processors 910 or processor-implemented modules are located in a single geographic location (e.g., within a home environment, an office environment, or a server farm). In other example embodiments, the processors or processor-implemented modules are distributed across a number of geographic locations.

The various memories and/or the storage unit 936 may store one or more sets of instructions 916 and data structures (e.g., software) embodying or utilized by any one or more of the methodologies or functions described herein. These instructions (e.g., the instructions 916), when executed by the processor(s), cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 916 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium” discussed below.

In some examples, one or more portions of the network 980 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

Described implementations of the subject matter can include one or more features, alone or in combination, as illustrated below by way of example.

Example 1. A system comprising: one or more hardware processors; and at least one machine-storage medium storing instructions that, when executed by the one or more hardware processors, cause the system to perform operations comprising: causing presentation, by a display device of a user, of a virtual interactive interface comprising one or more selectable items of a publication platform; receiving, from the user via the virtual interactive interface, input indicative of a selection of an item from among the one or more selectable items of the publication platform; generating a 3D model of the item, the 3D model of the item being generated by operations comprising: accessing an image of the item at a viewing angle; executing a trained multi-view diffusion model to generate a plurality of images of the item at a plurality of viewing angles based on the image of the item at the viewing angle; and generating the 3D model of the item based on the plurality of images of the item at the plurality of viewing angles; and causing presentation, by the display device of the user, of a virtual representation of the item within a 3D environment based on the 3D model of the item.

Example 2. The system of example 1, wherein the operations further comprise: receiving, from the user, input indicative of an interaction with the virtual representation of the item; and updating the presentation of the virtual representation of the item within the 3D environment according to the interaction received from the user.

Example 3. The system of example 2, wherein the interaction comprises at least one of pinching, dragging, or holding the virtual representation of the item.

Example 4. The system of any of examples 1-3, wherein the 3D model of the item is generated by operations comprising: executing a sparse-view reconstruction model to generate the 3D model of the item based on the plurality of the images of the item at the plurality of viewing angles.

Example 5. The system of any of examples 1-4, wherein the operations comprise training the trained multi-view diffusion model, the training of the trained multi-view diffusion model comprising: obtaining a preliminary multi-view diffusion model; obtaining a plurality of training data sets, each of the plurality of training data sets comprising an image of a training item paired with a 3D model of the training item; and for each of the plurality of training data sets, generating a plurality of first images of the training item at a plurality of training viewing angles based on the 3D model of the training item; executing the preliminary multi-view diffusion model to generate a plurality of second images of the training item at the plurality of training viewing angles based on the image of the training item; determining a reconstruction loss based on the plurality of the first images of the training item and the plurality of the second images of the training item; and updating the preliminary multi-view diffusion model to generate the trained multi-view diffusion model based on the reconstruction loss.

Example 6. The system of any of examples 1-5, wherein: the 3D environment comprises a real-world environment; and the display device comprises a transparent display configured to present the virtual representation of the item overlaid on the real-world environment.

Example 7. The system of any of examples 1-5, wherein: the 3D environment comprises a virtual environment; and the display device comprises an extended reality (XR) device or a virtual reality (VR) device configured to present the virtual environment.

Example 8. The system of example 7, wherein: the virtual environment comprises a representation of a real-world environment.

Example 9. The system of example 7 or 8, wherein: the user is a first user; and the operations comprise sharing the virtual environment with a second user.

Example 10. The system of any of examples 1-9, wherein the operations further comprise: implementing simultaneous localization and mapping (SLAM) to continuously track a position and an orientation of the display device; and continuously updating the presentation of the virtual representation of the item within the 3D environment based on the tracked position and orientation of the display device.

Example 11. The system of any of examples 1-10, wherein the operations further comprise: detecting solid objects in the 3D environment; and preventing the virtual representation of the item from intersecting with the detected solid objects.

Example 12. The system of any of examples 1-11, wherein the operations further comprise: implementing a spatial anchor to fix a position of the virtual representation of the item within the 3D environment.

Example 13. The system of any of examples 1-12, wherein: the virtual representation of the item within the 3D environment corresponds to actual physical dimensions of the item.

Example 14. A method comprising: causing presentation, by a display device of a user, of a virtual interactive interface comprising one or more selectable items of a publication platform; receiving, from the user via the virtual interactive interface, input indicative of a selection of an item from among the one or more selectable items of the publication platform; generating a 3D model of the item, the 3D model of the item being generated by operations comprising: accessing an image of the item at a viewing angle; executing a trained multi-view diffusion model to generate a plurality of images of the item at a plurality of viewing angles based on the image of the item at the viewing angle; and generating the 3D model of the item based on the plurality of images of the item at the plurality of viewing angles; and causing presentation, by the display device of the user, of a virtual representation of the item within the 3D environment based on the 3D model of the item.

Example 15. The method of example 14, wherein the 3D model of the item is generated by operations comprising: executing a sparse-view reconstruction model to generate the 3D model of the item based on the plurality of the images of the item at the plurality of viewing angles.

Example 16. The method of example 14 or 15, further comprising training the trained multi-view diffusion model, the training of the trained multi-view diffusion model comprising: obtaining a preliminary multi-view diffusion model; obtaining a plurality of training data sets, each of the plurality of training data sets comprising an image of a training item paired with a 3D model of the training item; and for each of the plurality of training data sets, generating a plurality of first images of the training item at a plurality of training viewing angles based on the 3D model of the training item; executing the preliminary multi-view diffusion model to generate a plurality of second images of the training item at the plurality of training viewing angles based on the image of the training item; determining a reconstruction loss based on the plurality of the first images of the training item and the plurality of the second images of the training item; and updating the preliminary multi-view diffusion model to generate the trained multi-view diffusion model based on the reconstruction loss.

Example 17. The method of example 16, wherein: the user is a first user; and the method further comprises sharing the virtual environment is a second user.

Example 18. The method of any of examples 14-17, further comprising: detecting solid objects in the 3D environment; and preventing the virtual representation of the item from intersecting with the detected solid objects.

Example 19. The method of any of examples 14-18, further comprising: implementing a spatial anchor to fix a position of the virtual representation of the item within the 3D environment.

Example 20. A machine-storage medium for storing instructions that, when executed by one or more hardware processors, cause the one or more hardware processors to perform operations comprising: causing presentation, by a display device of a user, of a three-dimensional (3D) environment; causing presentation, by the display device of the user, of a virtual interactive interface comprising one or more selectable items of a publication platform; receiving, from the user via the virtual interactive interface, a selection of an item from among the one or more selectable items of the publication platform; generating a 3D model of the item, the 3D model of the item being generated by operations comprising: accessing an image of the item at a viewing angle; executing a trained multi-view diffusion model to generate a plurality of images of the item at a plurality of viewing angles based on the image of the item at the viewing angle; and generating the 3D model of the item based on the plurality of images of the item at the plurality of viewing angles; and causing presentation, by the display device of the user, of a virtual representation of the item within the 3D environment based on the 3D model of the item.

What is claimed is:

1. A system comprising:
one or more hardware processors; and
at least one machine-storage medium storing instructions that, when executed by the one or more hardware processors, cause the system to perform operations comprising:
causing presentation, by a display device of a user, of a virtual interactive interface comprising one or more selectable items of a publication platform;
receiving, from the user via the virtual interactive interface, input indicative of a selection of an item from among the one or more selectable items of the publication platform;
generating a 3D model of the item, the 3D model of the item being generated by operations comprising:
accessing an image of the item at a viewing angle;
executing a trained multi-view diffusion model to generate a plurality of images of the item at a plurality of viewing angles based on the image of the item at the viewing angle; and
generating the 3D model of the item based on the plurality of images of the item at the plurality of viewing angles; and
causing presentation, by the display device of the user, of a virtual representation of the item within a 3D environment based on the 3D model of the item.

2. The system of claim 1, wherein the operations further comprise:
receiving, from the user, input indicative of an interaction with the virtual representation of the item; and
updating the presentation of the virtual representation of the item within the 3D environment according to the interaction received from the user.

3. The system of claim 2, wherein the interaction comprises at least one of pinching, dragging, or holding the virtual representation of the item.

4. The system of claim 1, wherein the 3D model of the item is generated by operations comprising:
executing a sparse-view reconstruction model to generate the 3D model of the item based on the plurality of the images of the item at the plurality of viewing angles.

5. The system of claim 1, wherein the operations comprise training the trained multi-view diffusion model, the training of the trained multi-view diffusion model comprising:
obtaining a preliminary multi-view diffusion model;
obtaining a plurality of training data sets, each of the plurality of training data sets comprising an image of a training item paired with a 3D model of the training item; and
for each of the plurality of training data sets,
generating a plurality of first images of the training item at a plurality of training viewing angles based on the 3D model of the training item;
executing the preliminary multi-view diffusion model to generate a plurality of second images of the training item at the plurality of training viewing angles based on the image of the training item;
determining a reconstruction loss based on the plurality of the first images of the training item and the plurality of the second images of the training item; and
updating the preliminary multi-view diffusion model to generate the trained multi-view diffusion model based on the reconstruction loss.

6. The system of claim 1, wherein:
the 3D environment comprises a real-world environment; and
the display device comprises a transparent display configured to present the virtual representation of the item overlaid on the real-world environment.

7. The system of claim 1, wherein:
the 3D environment comprises a virtual environment; and
the display device comprises an extended reality (XR) device or a virtual reality (VR) device configured to present the virtual environment.

8. The system of claim 7, wherein:
the virtual environment comprises a representation of a real-world environment.

9. The system of claim 7, wherein:
the user is a first user; and
the operations comprise sharing the virtual environment with a second user.

10. The system of claim 1, wherein the operations further comprise:
implementing simultaneous localization and mapping (SLAM) to continuously track a position and an orientation of the display device; and
continuously updating the presentation of the virtual representation of the item within the 3D environment based on the tracked position and orientation of the display device.

11. The system of claim 1, wherein the operations further comprise:
detecting solid objects in the 3D environment; and
preventing the virtual representation of the item from intersecting with the detected solid objects.

12. The system of claim 1, wherein the operations further comprise:
implementing a spatial anchor to fix a position of the virtual representation of the item within the 3D environment.

13. The system of claim 1, wherein:
the virtual representation of the item within the 3D environment corresponds to actual physical dimensions of the item.

14. A method comprising:
causing presentation, by a display device of a user, of a virtual interactive interface comprising one or more selectable items of a publication platform;
receiving, from the user via the virtual interactive interface, input indicative of a selection of an item from among the one or more selectable items of the publication platform;
generating a 3D model of the item, the 3D model of the item being generated by operations comprising:
accessing an image of the item at a viewing angle;
executing a trained multi-view diffusion model to generate a plurality of images of the item at a plurality of viewing angles based on the image of the item at the viewing angle; and
generating the 3D model of the item based on the plurality of images of the item at the plurality of viewing angles; and
causing presentation, by the display device of the user, of a virtual representation of the item within a 3D environment based on the 3D model of the item.

15. The method of claim 14, wherein the 3D model of the item is generated by operations comprising:
executing a sparse-view reconstruction model to generate the 3D model of the item based on the plurality of the images of the item at the plurality of viewing angles.

16. The method of claim 14, further comprising training the trained multi-view diffusion model, the training of the trained multi-view diffusion model comprising:
obtaining a preliminary multi-view diffusion model;
obtaining a plurality of training data sets, each of the plurality of training data sets comprising an image of a training item paired with a 3D model of the training item; and
for each of the plurality of training data sets,
generating a plurality of first images of the training item at a plurality of training viewing angles based on the 3D model of the training item;
executing the preliminary multi-view diffusion model to generate a plurality of second images of the training item at the plurality of training viewing angles based on the image of the training item;
determining a reconstruction loss based on the plurality of the first images of the training item and the plurality of the second images of the training item; and
updating the preliminary multi-view diffusion model to generate the trained multi-view diffusion model based on the reconstruction loss.

17. The method of claim 16, wherein:
the user is a first user; and
the method further comprises sharing the virtual environment with a second user.

18. The method of claim 14, further comprising:
detecting solid objects in the 3D environment; and
preventing the virtual representation of the item from intersecting with the detected solid objects.

19. The method of claim 14, further comprising:
implementing a spatial anchor to fix a position of the virtual representation of the item within the 3D environment.

20. A machine-storage medium for storing instructions that, when executed by one or more hardware processors, cause the one or more hardware processors to perform operations comprising:
causing presentation, by a display device of a user, of a virtual interactive interface comprising one or more selectable items of a publication platform;
receiving, from the user via the virtual interactive interface, input indicative of a selection of an item from among the one or more selectable items of the publication platform;
generating a 3D model of the item, the 3D model of the item being generated by operations comprising:
accessing an image of the item at a viewing angle;
executing a trained multi-view diffusion model to generate a plurality of images of the item at a plurality of viewing angles based on the image of the item at the viewing angle; and
generating the 3D model of the item based on the plurality of images of the item at the plurality of viewing angles; and
causing presentation, by the display device of the user, of a virtual representation of the item within a 3D environment based on the 3D model of the item.
